(19) United States
(12) Patent Application Publication
(10) Pub. No.: US 2009/0034124 A1
(43) Pub. Date: Feb. 5, 2009

(54) IMPRINT MOLD STRUCTURE, METHOD FOR PRODUCING MAGNETIC RECORDING MEDIUM, AND MAGNETIC RECORDING MEDIUM

(75) Inventors: Kenji Ichikawa, Kanagawa (JP); Toshihiro Usa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/143,533

(22) Filed: Jun. 20, 2008

(30) Foreign Application Priority Data
Jun. 21, 2007 (JP) 2007-163782

(51) Int. Cl. G11B 5/82; B29C 59/02

(52) U.S. Cl. 360/135; 425/385; 264/299; G9B/5.293

(57) ABSTRACT

An imprint mold structure of the present invention is for producing a magnetic recording medium having servo areas each of which has a preamble area where servo data for synchronization with a clock cycle is recorded, and data areas where user data is written, and contains a first convexo-concave pattern corresponding to the servo areas and a second convexo-concave pattern corresponding to the data areas, wherein a ratio L/S of a width “L” in the circumferential direction of a convex portion corresponding to a non-magnetic portion formed in the preamble area to a width “S” in the circumferential direction of a concave portion corresponding to a magnetic portion formed in the preamble area varies depending on a distance “R” from a center of the imprint mold structure to a center of a pattern unit composed of the convex portion and the concave portion in the first convexo-concave pattern.

### BACKGROUND OF THE INVENTION

1. Field of the Invention

The present invention relates to an imprint mold structure, a method for producing a magnetic recording medium using the imprint mold structure, and a magnetic recording medium prepared by the method for producing a magnetic recording medium.

2. Description of the Related Art

In a magnetic recording medium such as a hard disc (HD), besides data areas where data can be written, there are servo areas where servo information for positioning a magnetic head to a desired track and sector location.

As a method of producing a magnetic recording medium, there is generally known a method for producing a magnetic recording medium utilizing imprint lithography.

In imprint lithography, an imprint mold structure (imprint stamper) is prepared which has micro-protrusions or convex portions, the pattern of which is an inverted pattern of a magnetic pattern formed on a surface of a magnetic recording medium, according to the following method. First, an electron beam resist is applied over a surface of an Si substrate, a predetermined pattern is drawn using an electron beam, and the pattern is developed to form a convexo-concave pattern of an electron beam resist. Next, the Si substrate with the convexo-concave pattern of the electron beam resist formed on the surface thereof is subjected to an electrocasting treatment, and a metal disc formed by electrocasting is peeled off from the Si substrate, thereby preparing an imprint mold structure. Further, a magnetic recording medium is prepared by, for example, an imprint lithographic method as described below. A magnetic film is formed on a surface of a substrate, and a resist is applied over the surface of the substrate. An imprint mold structure is pressed against the surface of the resist to transfer convexo-concaves formed on the surface of the imprint mold structure to the resist surface. After removing the imprint mold structure, the resist with the convexo-concaves transferred thereto is used as a mask to process the magnetic film, thereby a magnetic recording medium with a desired magnetic pattern formed on a surface thereof is produced.

However, there is a problem that a finally formed magnetic pattern bulges out more than the original convexo-concave pattern of the imprint mold structure. That is, when a magnetic recording medium is prepared by imprint lithography using an imprint mold structure where different patterns are mixed, the stress applied to a resist when the resist is pressed by the imprint mold structure varies depending on the area ratio between portions where a pattern exists (convex portions or protrusions in the imprint mold structure) and portions where no pattern exists (concave portions or recesses in the imprint mold structure).

Specifically, the smaller convex portions in the imprint mold structure, the easier a desired pushed depth can be obtained in a resist using the imprint mold structure, whereas in an area where convex portions in an imprint mold structure are large, it is difficult to obtain a desired pushed depth. Therefore, the resist should be pushed by the imprint mold structure by adapting the stress level to an area in the resist where the stress is exerted at the smallest level, and areas in the resist where the stress is largely exerted is pushed with an excessive force. Therefore, magnetic patterns in size differ among areas that have a different convexo-concave ratio or have a different ratio between convex portions and concave portions in an imprint mold structure, more specifically, among areas having a different magnetic occupancy rate which respectively correspond to a data area, a preamble area, a burst area and an address area.

In a currently available magnetic recording medium, the magnetic occupancy rate of a data area is about 65% to 75%, whereas the magnetic occupancy rate of a burst area in a servo area is 75%, and the magnetic occupancy rate of a preamble area and the magnetic occupancy rate of an address area are respectively 50%. As described above, since the magnetic occupancy rate widely varies on an-area-to-area basis, it is difficult to form a pattern by transfer on a surface of a resist with the use of an imprint mold structure. In particular, the magnetic occupancy rate of a preamble area, which has the longest area length in a servo area, is 50%, this magnetic occupancy rate largely deviates from the magnetic occupancy rate of a data area which is about 70%. This point makes it difficult to form a pattern in a stable manner by transfer from an imprint mold structure to a surface of a resist.

Even when each of the magnetic occupancy rates are equalized throughout the entire areas in a magnetic recording medium in order to allow for stably forming a pattern with the use of an imprint mold structure, the amplitude of reproducing signals in a preamble area is reduced at a part of the area in the middle of reproducing process.

To eliminate the problem, in a preamble area, which has a wide area, the magnetic occupancy rate of magnetic portions is made to be different from the magnetic occupancy rate of non-magnetic portions to set a difference in magnetic occupancy rate between the preamble area and a data area within the range of ±10%, a ratio between convex portions and concave portions in an imprint mold structure used when a magnetic surface is formed in a production process of a magnetic recording medium becomes substantially equalized in the entire surface of the imprint mold structure, and a difference in stress applied to the magnetic recording medium at the time of transferring a pattern to the magnetic surface through the use of the imprint mold structure is reduced, thereby making it possible to stably produce a magnetic recording medium in which a pattern is formed on the entire magnetic surface thereof by transfer using an imprint mold structure (for example, see Japanese Patent Application Laid-Open (JP-A) No. 2006-179128).

Further, for a servo pattern with a constant angular velocity employed in a magnetic disc storage device (HDD), attempts have been made to design a mold that is prepared in view of flowability of resin used in nanoimprint lithography (NIL) and processability such as correction of variations in line width by etching process. For example, there has been already known an information recording medium in which a convexo-concave pattern constituting a servo pattern is designed by defining the length of unit of convex portions for each circular area such that a value obtained by dividing the average length of units of convex portions in each circular area by a distance from the center of a data track pattern to each of the circular areas is set to be smaller in circular areas positioned at the outer circumferential side of the recording medium than in circular areas positioned at the inner circumferential side of the recording medium (for example, see 2006-120299).

Since a line width of a convexo-concave pattern in a servo area is determined by a clock cycle, a pattern formed nearer the outer circumferential side of a recording medium has a wider width, and a pattern formed nearer the inner circumferential side has a narrower width. Whereas, in a discrete track medium (DTM), a groove pitch formed in the circumferential direction of the medium needs to be set constant to the track pitch. In nanoimprint lithography (NIL) techniques, when an imprint mold structure is pressed against a resin, the formability of a convexo-concave pattern differs depending on the volume of the resin transferred, and therefore there is a need to optimize the ratio between convex portions and concave portions in the pattern in accordance with the radius position. Also, in an etching process of a convexo-concave pattern, when the line width of a processed portion is 100 nm or narrower, the etching rate is lowered as compared with the case where the line width of a processed portion is 100 nm or wider. Therefore, it is difficult to bring the ratio of line width between magnetic portions and non-magnetic portions in a finally formed magnetic recording medium in line with the ratio of convex portions and concave portions in a pattern for all servo areas of a mold structure even when the ratio of convex portions and concave portions in a pattern is fixed.

### BRIEF SUMMARY OF THE INVENTION

The present invention aims to solve the prior art problems and achieve the following objects. Specifically, the objects of the present invention are to provide an imprint mold structure capable of substantially equalizing the flowability of resin by an imprint process and the processability of a magnetic recording medium that has been subjected to an etching process by varying a line width of a processed portion, i.e., by varying a ratio L/S depending on a distance R from the center of the imprint mold structure to the center of a pattern unit composed of a convex portion and a concave portion in a convexo-concave pattern corresponding to a preamble area, a method for producing a magnetic recording medium and a magnetic recording medium.

The means for solving the aforesaid problems are as follows.

<1> An imprint mold structure for producing a magnetic recording medium, the magnetic recording medium having servo areas each of which has a preamble area where servo data for synchronization with a clock cycle is recorded, and data areas where user data is written, the imprint mold structure having a first convexo-concave pattern corresponding to the servo areas in the magnetic recording medium, and a second convexo-concave pattern corresponding to the data areas in the magnetic recording medium, wherein a ratio L/S of a width “L” in a circumferential direction of a convex portion corresponding to a non-magnetic portion formed in the preamble area to a width “S” in a circumferential direction of a concave portion corresponding to a magnetic portion formed in the preamble area varies depending on a distance “R” from a center of the imprint mold structure to a center of a pattern unit composed of the convex portion and the concave portion in the first convexo-concave pattern.

<2> The imprint mold structure according to the item <1>, wherein the ratio L/S is within the range of from 0.33 to 0.83.

<3> The imprint mold structure according to any one of the items <1> to <2>, wherein a ratio L/S of a width “L” in a radial direction of a convex portion corresponding to a non-magnetic portion formed in one of the data areas to a width “S” in a radial direction of a concave portion corresponding to a magnetic portion formed in the data area is kept constant.

<4> A method for producing a magnetic recording medium which includes using the imprint mold structure according to any one of the items <1> to <3>.

<5> A magnetic recording medium produced by the method for producing a magnetic recording medium according to the item <4>.

The present invention can solve the prior art problems, achieve the above-mentioned objects and provide an imprint mold structure capable of substantially equalizing the flowability of resin by an imprint process and the processability of a magnetic recording medium that has been subjected to an etching process by varying a line width of a processed portion, i.e., by varying a ratio L/S depending on a distance R from the center of the imprint mold structure to the center of a pattern unit composed of a convex portion and a concave portion in a convexo-concave pattern corresponding to a preamble area, a method for producing a magnetic recording medium and a magnetic recording medium.

### BRIEF DESCRIPTION OF THE SEVERAL VIEWS OF THE DRAWINGS

FIG. 1 is a plain view exemplarily showing a schematic structure of a magnetic recording medium of the present invention.

FIG. 2 is an enlarged view showing a data area 110 and a servo area 120 in the magnetic recording medium shown in FIG. 1.

FIG. 3 is a view exemplarily explaining the servo area 120 shown in FIG. 2.

FIG. 4 is a plain view exemplarily showing a schematic structure of an imprint mold structure according to the present invention.

FIG. 5 is a plain view exemplarily showing a partial structure of an imprint mold structure according to the present invention.

FIG. 6 is a view explaining a convexo-concave pattern 410 shown in FIG. 5.

FIG. 7 is a view explaining a convexo-concave pattern 420 shown in FIG. 5.

FIG. 8A is a cross-sectional view exemplarily showing a method for producing an imprint mold structure according to the present invention.

FIG. 8B is another cross-sectional view exemplarily showing a method for producing an imprint mold structure according to the present invention.

FIG. 9 is a cross-sectional view exemplarily showing a method for producing a magnetic recording medium using an imprint mold structure according to the present invention.

### DETAILED DESCRIPTION OF THE INVENTION

Hereinafter, an imprint mold structure according to the present invention will be described with reference to the appended drawings.

### (Magnetic Recording Medium)

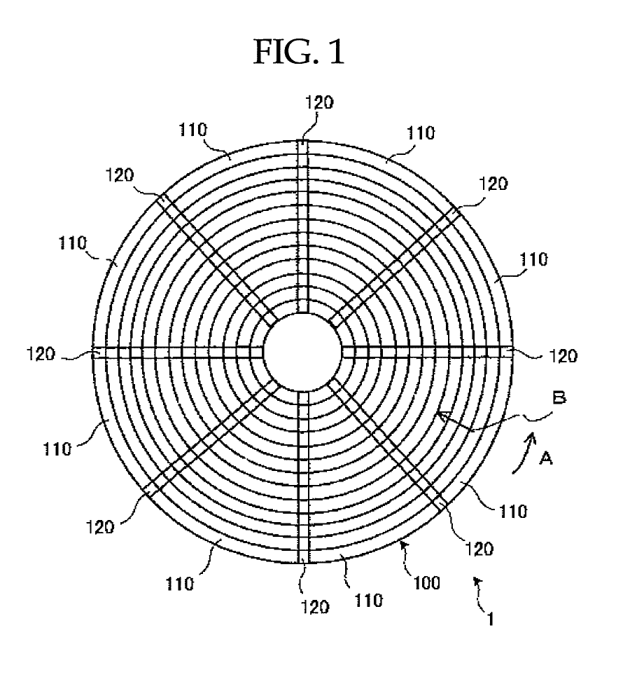

FIG. 1 is a plain view exemplarily showing a schematic structure of a magnetic recording medium of the present invention.

In FIG. 1, a magnetic recording medium 1 is provided with at least a plurality of tracks 100 formed in a concentric pattern on a surface of the magnetic recording medium, a plurality of servo areas 120 generally radially formed on the surface and a plurality of data areas 110 that are split by each of the servo areas 120 and is further provided with other members in accordance with the necessity. Note that in FIG. 1, the direction “A” indicates the circumferential direction of the magnetic recording medium 1 and the direction “B” indicates a radial direction.

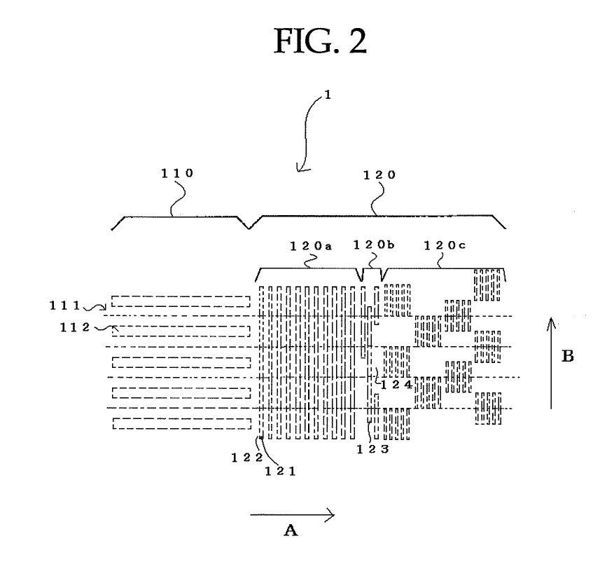

FIG. 2 is an enlarged view showing the data area 110 and the servo area 120 in the magnetic recording medium shown in FIG. 1.

In FIG. 2, the magnetic recording medium 1 has a structure where the data areas 110 are arranged in parallel in a track direction of each of the servo areas 120.

### —Data Area—

Each of the data areas 110 is an area in which user data can be written by means of a magnetic head of a magnetic recording/reproducing apparatus.

In the data areas 110, a plurality of tracks are formed which have magnetic bands 111 in which user data can be written by means of a magnetic head, and non-magnetic bands 112 in which user data cannot be written are formed between the adjacent tracks. In other words, the magnetic recording medium 1 is a discrete track recording medium in which the magnetic bands 111 are physically split by each of the non-magnetic bands 112.

### —Servo Area—

Each of the servo areas 120 is an area in which servo data for detecting on a magnetic recording medium a position of a magnetic head of a magnetic recording/reproducing apparatus is previously recorded.

In each of the servo areas 120, magnetic portions 122, 124 and non-magnetic portions 121, 123 are formed by transfer with the use of the entire surface of an imprint mold structure (stamper) in production of a magnetic recording medium. The non-magnetic portions 121 and 123 are structured so as to be filled with a non-magnetic material, however, these portions are not necessarily filled with a non-magnetic material. When servo data recorded in the servo area 120 is reproduced by a magnetic head of a magnetic recording/reproducing apparatus, each of the magnetic portions 122 and 124 is reproduced as a binary value “0”, and each of the non-magnetic portions 121 and 123 is reproduced as a binary value “1”.

Each of the servo areas 120 is composed of a preamble area 120a, an address area 120b and a burst area 120c as shown in FIG. 2.

The magnetic recording medium 1 employs a perpendicular magnetic recording mode in which a magnetic film is magnetized in a perpendicular direction (in a thickness direction of the recording medium) in the magnetic portions 122, 124 and the magnetic bands 111. Further, in the magnetic recording medium 1, the non-magnetic band 112 and the non-magnetic portions 121 and 123 are structured so as to be filled with a non-magnetic material, however, the non-magnetic band 112 and the non-magnetic portions 121 and 123 may be respectively structured to have a void, instead of filling them with a non-magnetic material.

The preamble area 120a is an area in which servo data for synchronization with a clock cycle is recorded, and a magnetic portion 122 corresponding to a code “1” in the servo data and a non-magnetic portion 121 corresponding to a code “0” are formed. Data recorded in the preamble area 120a is read by a magnetic head before data recorded in the address area 120b and the burst area 120c.

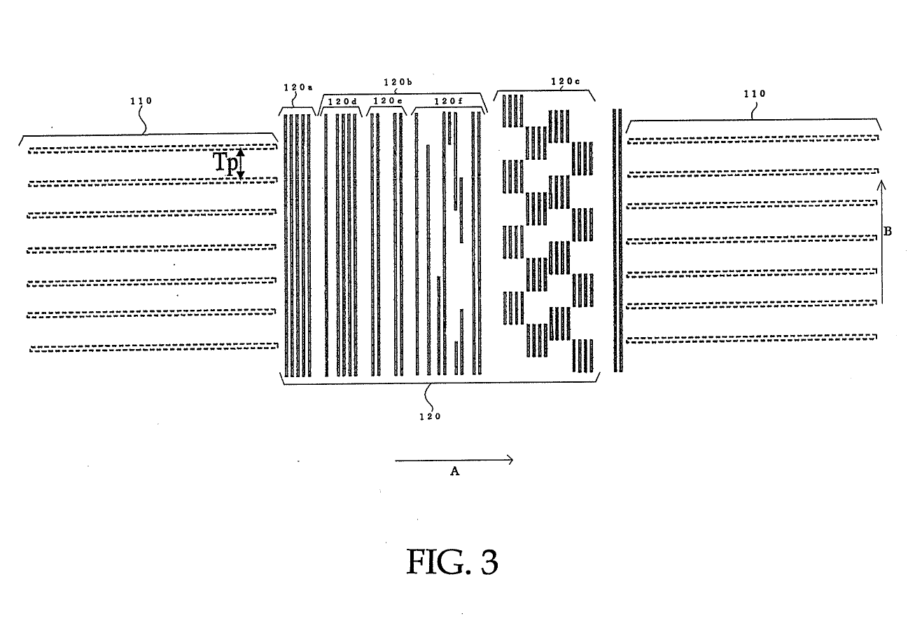

The address area 120b is an area in which servo data including a code identified as a servo mark 120d, sector information 120e, cylinder information 120f and the like (FIG. 3) are recorded by the dibit mode in which a binary value “0” is represented by a code “01” and a binary value “1” is represented by a code “10”. In the address area 120b, a non-magnetic portion 123 for the servo data, corresponding to the code “1” based on a dibit mode, and a magnetic portion 124 for the servo data corresponding to the code “0” based on the dibit mode are formed. In place of the dibit mode, Manchester encoding method can be utilized as well.

The burst area 120c is an area in which servo data for requesting information on a location deviation that is a relative position of a magnetic head to the center position of tracks is recorded.

### —Other Members—

The other members are not particularly limited and may be suitably selected in accordance with the intended use as long as the effects of the present invention are not impaired.

### (Imprint Mold Structure)

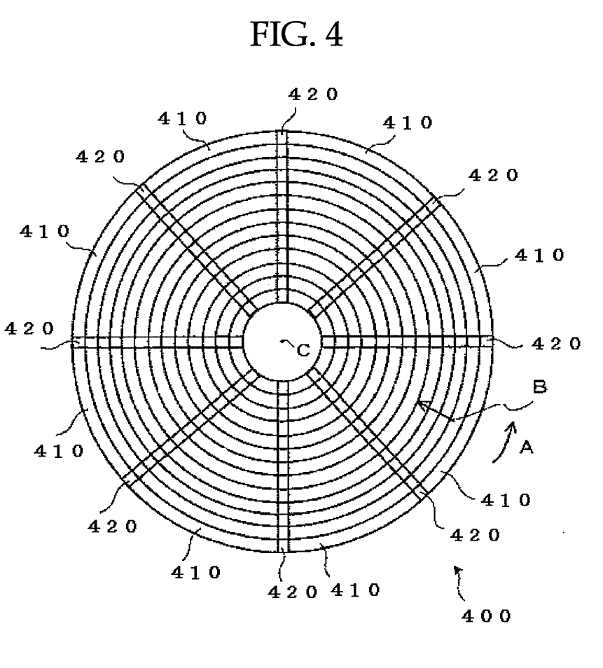

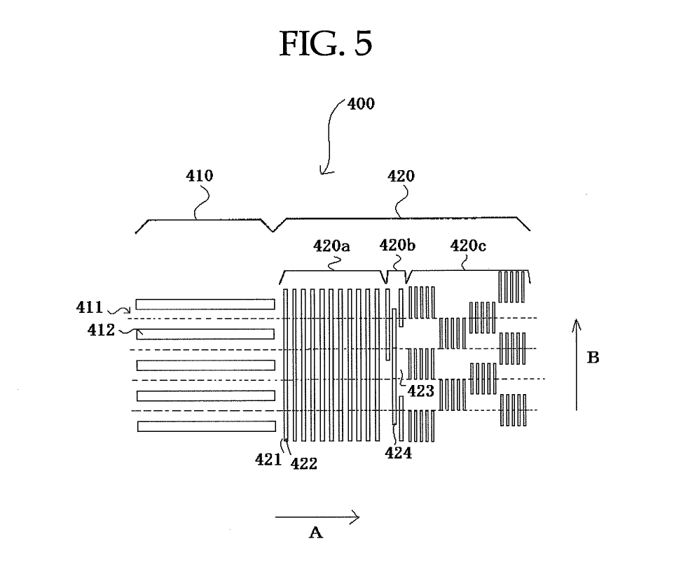

FIG. 4 is a plain view exemplarily showing a schematic structure of an imprint mold structure according to the present invention. FIG. 5 is a plain view exemplarily showing a partial structure of an imprint mold structure according to the present invention.

As shown in FIG. 4 and FIG. 5, an imprint mold structure 400 is used for producing the magnetic recording medium 1 described above, has at least a plurality of convexo-concave patterns 410 corresponding to the data areas 110 and a plurality of convexo-concave patterns 420 corresponding to the servo areas 120 and further has other members in accordance with the necessity.

### —Convexo-Concave Pattern Corresponding to Data Area—

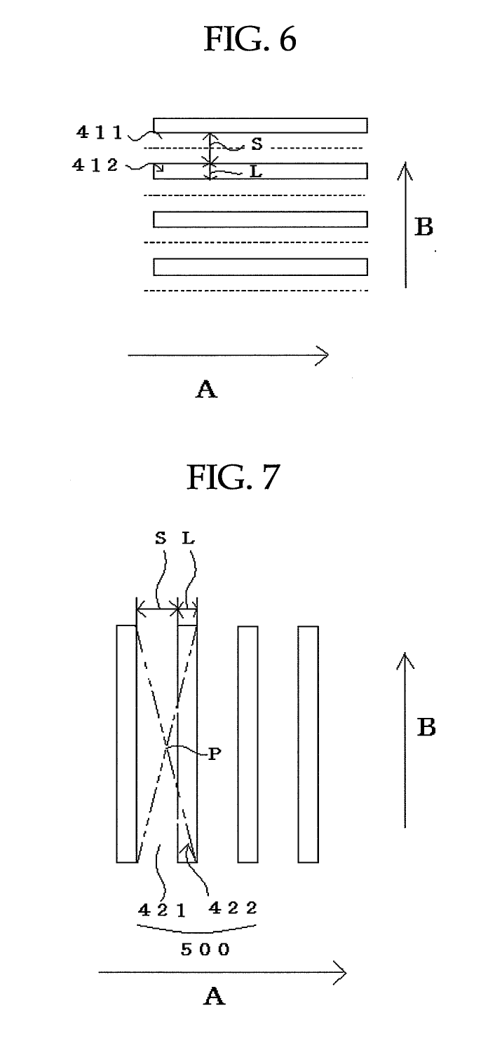

Each of the convexo-concave patterns 410 corresponding to one of the data areas 110 has a concave portion 411 corresponding to the magnetic band 111 and a convex portion 412 corresponding to the non-magnetic portion 112. As shown in FIG. 6, a ratio L/S of a width “L” in a radial direction of the convex portion 412 corresponding to the non-magnetic band 112 in the data area to a width “S” in a radial direction of the concave portion 411 corresponding to the magnetic band 111 in the data area is kept constant.

### —Convexo-Concave Pattern Corresponding to Servo Area—

Each of the convexo-concave patterns 420 corresponding to one of the servo areas 120 is composed of a convexo-concave pattern 420a which corresponds to the preamble area 120a, a convexo-concave pattern 420b which corresponds to the address area 120b and a convexo-concave pattern 420c which corresponds to the burst area 120c.

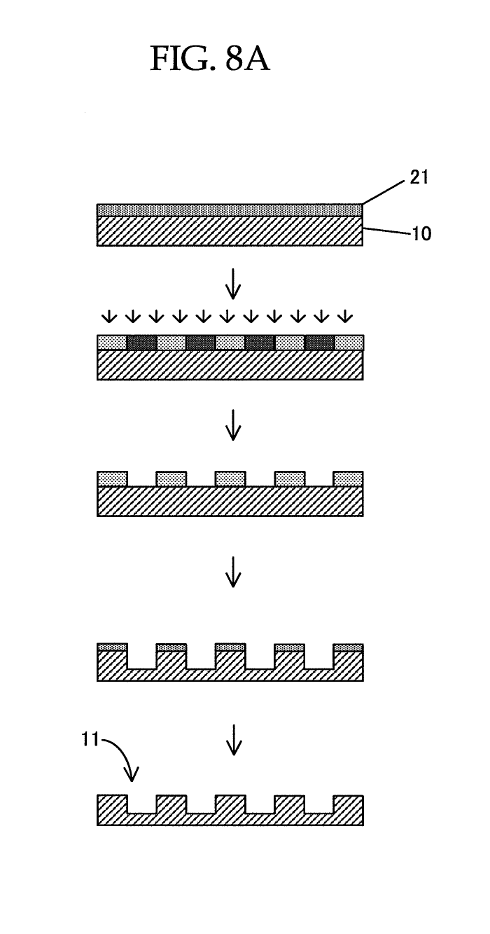

The convexo-concave pattern 420a has a concave portion 421 corresponding to the magnetic portion 122 and a convex portion 422 corresponding to the non-magnetic portion 121. The convexo-concave pattern 420b has a concave portion 423 corresponding to the magnetic portion 124 and a convex portion 424 corresponding to the non-magnetic portion 123. As shown in FIG. 7, a ratio L/S of a width “L” in the circumferential direction of the convex portion 422 corresponding to the non-magnetic portion 121 in the preamble area to a width “S” in the circumferential direction of the concave portion 421 corresponding to the magnetic portion 122 in the preamble area varies depending on a distance “R” from a center C (FIG. 4) of the imprint mold structure to a center P of a pattern unit 500 (FIG. 7) composed of the convex portion 422 and the concave portion 421 in the convexo-concave pattern 420a corresponding to the preamble area 120a, and the ratio L/S is within the range of from 0.33 to 0.83.

### —Other Members—

The other members are not particularly limited and may be suitably selected in accordance with the intended use as long as the effects of the present invention are not impaired. For example, a mold surface layer provided with a function of peeling off imprint resist layers and a carbon film provided as a protective film are exemplified.

### <Method for Producing Imprint Mold Structure>

Hereinafter, one example of a method for producing an imprint mold structure 400 used in the present invention will be described with reference to the appended drawings. Note that the imprint mold structure 400 used in the present invention may be produced by a production method other than the following production method of an imprint mold structure.

### —Preparation of Original Master—

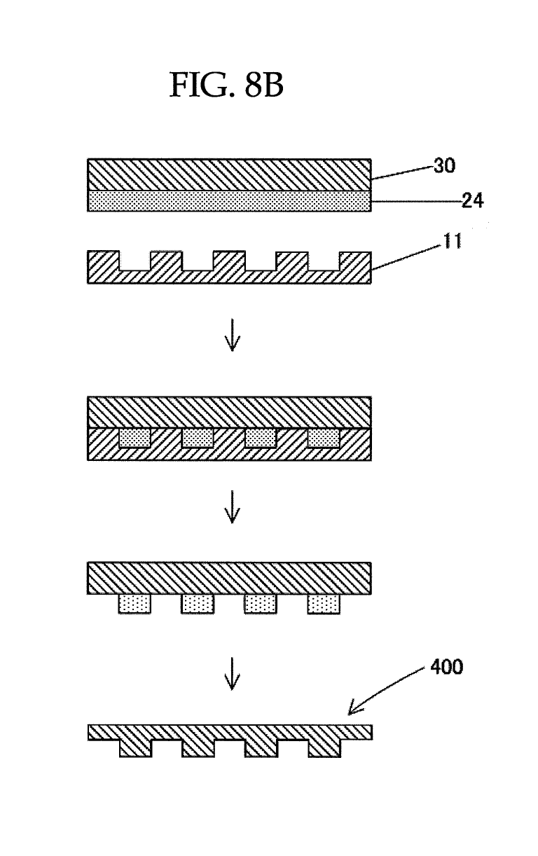

FIG. 8A and FIG. 8B are respectively a cross-sectional view exemplarily showing a method for producing an imprint mold structure 400. As shown in FIG. 8A, first, an electron beam solution is applied over a surface of an Si substrate 10 by spin-coating or the like to form a photoresist layer 21.

Then, the Si substrate 10 is irradiated with an electron beam that is modulated according to a servo signal with rotating the Si substrate 10 to expose a predetermined pattern on the entire photoresist surface. For example, a pattern corresponding to a servo signal that extends linearly in a radial direction of each track from the rotational center is exposed at a portion corresponding to each frame on the circumference of the Si substrate 10.

Subsequently, the photoresist layer 21 is developed to remove those portions exposed, the pattern of the photoresist layer 21 from which those portions have been removed is used as a mask and selectively etched by RIE to thereby obtain an original master 11 with convexo portions and concaves portions formed on a surface thereof.

### —Preparation of Imprint Mold Structure—

Next, as shown in FIG. 8B, the original master 11 is pressed against a quartz substrate 30 used as a substrate to be processed, in which an imprint resist layer 24 is formed on a first surface by applying an imprint resist solution containing a photocurable resin over the first surface, and then the convexo-concave pattern formed on the original master 11 is transferred to the surface of the imprint resist layer 24.

A material used for the substrate to be processed is not particularly limited and may be suitably selected in accordance with the intended use as long as the material has optical transparency and has such strength that it functions as a mold structure. For example, quartz (SiO₂) is exemplified.

The description “the material has optical transparency” specifically means that when a light beam is incident from a certain surface other than the first surface of the substrate to be processed such that the light beam exits from the first surface on which the imprint resist layer has been formed, the imprint resist is sufficiently cured, and means that the light transmittance of light beam emitted from the certain surface to the first surface of the substrate is 50% or more.

Further, the description “the material has such strength that it functions as a mold structure” means that the material has such strength that it can bear stress when a mold structure is pressed against an imprint resist layer formed on a substrate of a magnetic recording medium under the condition of an average surface pressure of 4 kgf/cm² and the imprint resist layer is pressurized.

### —Curing Step—

After the transfer of the convexo-concave pattern, the imprint resist layer 24 is irradiated with an ultraviolet ray to cure the transferred pattern.

### —Pattern Forming Step—

Subsequently, the transferred pattern is used as a mask and selectively etched by RIE or the like, thereby obtaining an imprint mold structure 400 with a convexo-concave formed on a surface thereof.

Note that the imprint mold structure 400 described above represents an imprint mold structure produced by nanoimprint lithography (NIL) utilizing ultraviolet ray, but the imprint molt structure of the present invention is not limited thereto. For example, the imprint mold structure of the present invention may be produced by nanoimprint lithography (NIL) utilizing heat, in which an Ni conductive layer is provided to the original master 11 with convexo-concaves formed on a surface thereof, and the Ni conductive layer is subjected to an Ni electrocasting treatment and then peeled off from the original master 11 to thereby obtain an Ni mold.

### (Method for Producing Magnetic Recording Medium)

Hereinafter, a method for producing a magnetic recording medium 1 (such as discrete track medium and pattern medium) using an imprint mold structure 400 will be described with reference to the appended drawings. The method for producing a magnetic recording medium 1 of the present invention may be a production method other than the production method described below as long as an imprint mold structure 400 is used in the production method.

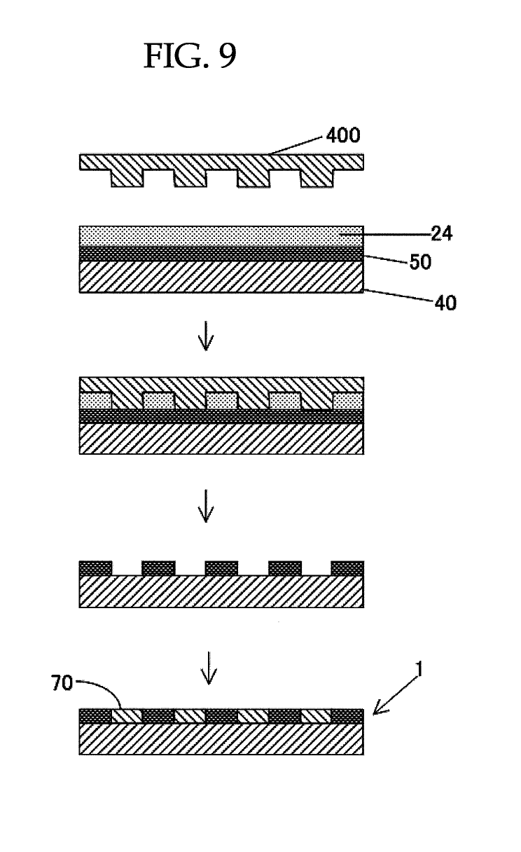

As shown in FIG. 9, an imprint mold structure 400 is pressed against a substrate 40 of a magnetic recording medium 1 in which a magnetic layer 50 and an imprint resist layer 24 formed by applying an imprint resist solution are formed in this order on the substrate 40 so as to pressurize the magnetic recording medium 1, thereby the convexo-concave pattern formed on the surface of the imprint mold structure 400 is transferred to the surface of the imprint resist layer 24.

Then, the imprint resist layer 24, in which the convexo-concave pattern formed using the imprint mold structure 400 is transferred to the surface thereof, is used as a mask and selectively etched by RIE or the like to form a convexo-concave pattern, which has been formed on the imprint mold structure 400, on the surface of the magnetic layer 50, and then a non-magnetic material 70 is embedded in concave portions to planarize the magnetic layer 50, followed by forming a protective layer and the like on the magnetic layer 50 as necessary thereby obtaining the magnetic recording medium 1.

### EXAMPLES

Hereinafter, the present invention will be further described in detail referring to Examples and Comparative Examples, however, it is to be understood that the present invention is not limited to the disclosed Examples. On the contrary, the present invention is intended to cover various modifications and equivalent configurations included within the spirit and scope of the appended claims.

### <Preparation of Imprint Mold Structure>

Five Ni-plated molds were prepared, in which a ratio L/S of a width “L” in the circumferential direction of a convex portion corresponding to a non-magnetic portion formed in a preamble area to a width “S” in the circumferential direction of a concave portion corresponding to a magnetic portion formed in the preamble area was set on five levels of 1/1, 5/6, 2/3, 1/2 and 1/3, and the radiuses in the entire surface of these molds were set equal to each other. Note that the line width of each of the preamble areas was adjusted with electric current applied thereto in the lithographic process using electron beam.

### <<Measurement of Ration L/S>>

For the measurement of the ratio L/S of each of these molds, a portion corresponding to an preamble area of the prepared Ni-plated mold was cut into a strip using a focused ion beam (FIB), the cross-section of the strip was observed using a transmission electron microscope, and from an image obtained through the transmission electron microscope, a half-value of the pattern height was calculated.

For the ratio L/S of signals, a ratio L/S at a zero cross position of a waveform was measured using a spin-stand, and the measured value was digitized.

### <Preparation of Magnetic Recording Medium>

Each of the prepared imprint mold structures was pressed against a substrate of a magnetic recording medium in which a magnetic layer and an imprint resist layer formed by applying an imprint resist solution such as PMMA were formed in this order on the substrate so as to pressurize the magnetic recording medium, thereby the convex pattern formed on the surface of the imprint mold structure was transferred to the surface of the imprint resist layer.

Note that when pressing the mold structure against the surface of the imprint resist layer, the temperature of the system was kept near the glass transition temperature (Tg) of the resist solution, and after the transfer of the pattern to the surface of the imprint resist layer, the temperature of the imprint resist layer was controlled to be lower than the glass transition temperature (Tg) of the resist solution, followed by curing of the imprint resist layer.

Subsequently, the imprint resist layer with the convex pattern transferred to the surface thereof was used as a mask and selectively etched by RIE, etc. to form a magnetic layer so as to have a convexo-concave pattern form on the surface thereof according to the pattern that had been formed on the mold structure, and a non-magnetic material was embedded in concave portions to planarize the magnetic layer to thereby obtain a magnetic recording medium.

Specifications of the servo are as follows.

### <Specifications of Servo>

(1) basic frequency of servo clock “f”: 2.0 MHz (180 MHz at 5,400 rpm) A=2πR/f(R=15 mm, A=47.12 nm; R=30 mm, A=94.25 nm)
(2) Tp=140 nm
(3) the number of sectors: 128
(4) servo control: 4-Burst system
(5) distance R from a center C of the imprint mold structure to a center P of a pattern unit composed of a convex portion and a concave portion in a convexo-concave pattern corresponding to a preamble area: 14 mm to 31 mm
(6) height of convexo-concave pattern: 70 nm

### <<Evaluation of Recording Medium at Off-Track >>

Using a spin-stand manufactured by Kyodo Denki System K.K., the prepared recording media were evaluated at off-track. For the magnetic head used in the embodiments, a GMR head was used, and the width of Read head was set same as the width of Tp (140 nm).

<<Relation Between Ratio L/S for Each Distance R from a Center C of an Imprint Mold Structure to a Center P of a Pattern Unit Composed of a Convex Portion and a Concave Portion in a Convexo-Concave Pattern Corresponding to a Preamble Area and Evaluation Result of Signal Width >>

The results of a relation between a ratio L/S for each distance R from a center C of each of the prepared imprint mold structures to a center P of a pattern unit composed of a convex portion and a concave portion in a convexo-concave pattern corresponding to a preamble area and the evaluation result of signal widths of the magnetic recording media prepared using each of the imprint mold structures are shown in Table 1 below. In Table 1, each of numeric values in the column of “1T” indicates a line width calculated from a clock cycle, and “-” in the column of “Signal width (nm) of recording medium to L/S ratio of mold” indicates that no pattern was formed.

TABLE 1

| | | Signal width (nm) of recording medium | | | | |
|---|---|---|---|---|---|---|
| Distance R | | to L/S ratio of mold | | | | |
| from center | | L/S = | L/S = | | | |
| C | 1 T | 1/1 | 5/6 | L/S = 4/6 | L/S = 1/2 | L/S = 1/3 |
| R = 27 mm | 85 nm | 136 | 122 | 103 | 95 | 83 |
| R = 25 mm | 75 nm | 113 | 103 | 90 | 78 | 70 |
| R = 21 mm | 66 nm | 93 | 83 | 72 | 67 | — |
| R = 18 mm | 56 nm | 73 | 65 | 58 | 52 | — |
| R = 15 mm | 47 nm | 62 | 53 | 48 | — | — |

Based on the results shown in Table 1, an optimum value obtained when a ratio of a line width calculated based on the clock cycle to the signal width of the recording medium is 1:1 is calculated as shown in Table 2.

TABLE 2

| | Designed |
|---|---|
| Distance R | value of |
| from center C | L/S ratio |
| R = 27 mm | 0.38 |
| R = 25 mm | 0.42 |
| R = 21 mm | 0.53 |
| R = 18 mm | 0.61 |
| R = 15 mm | 0.65 |

Based on the calculated value from the experimental value of L/S ratio shown in Table 2, an approximate expression was obtained using polynominal approximation method. As a result, the following Relational Expression (1) was derived.

Y=0.799−0.0018X−(5.17×10⁻⁴)X² Relational Expression (1)

where “X” represents a distance “R”, and “Y” represents a ratio L/S.

The Relational Expression (1) varies depending on variations of basic frequency of a servo clock and conditions for nanoimprint lithography (NIL), which is based on the fact that the line width varies depending on the basic frequency of a servo clock and the volume of resist transferred during imprint process varies depending on the conditions for nanoimprint lithography (NIL) employed.

The value calculated from the Relational Expression (1) was fed back to lithographic conditions, and the lithographic conditions were patterned. Based on the patterned lithographic conditions (such conditions that a ratio L/S varies depending on the distance R from the center C of the imprint mold structure to the center P of a unit pattern composed of a convex portion and a concave portion in a convexo-concave pattern corresponding to a preamble area), one imprint mold structure was prepared. Table 3 shows signal widths of the magnetic recording media obtained after the imprinting process using the prepared imprint mold structure.

TABLE 3

| | Designed | |
|---|---|---|
| Distance R | value of | Width of |
| from center C | L/S ratio | signal |
| R = 27 mm | 0.37 | 85 nm |
| R = 25 mm | 0.43 | 74 nm |
| R = 21 mm | 0.53 | 65 nm |
| R = 18 mm | 0.60 | 57 nm |
| R = 15 mm | 0.66 | 48 nm |

As described above, by using an imprint mold structure in which a ratio L/S of a width “L” in the circumferential direction of a convex portion corresponding to a non-magnetic portion formed in the preamble area to a width “S” in the circumferential direction of a concave portion corresponding to a magnetic portion formed in the preamble area varied depending on a distance “R” from the center of the imprint mold structure to the center of a pattern unit composed of the convex portion and the concave portion in the first convexo-concave pattern, it was possible to provide a magnetic recording medium in which the flowability of resin by an imprint process and the processability of the magnetic recording medium that has been subjected to an etching process are substantially equalized.

What is claimed is:

1. An imprint mold structure for producing a magnetic recording medium, the magnetic recording medium having servo areas each of which has a preamble area where servo data for synchronization with a clock cycle is recorded, and data areas where user data is written, the imprint mold structure comprising:
a first convexo-concave pattern corresponding to the servo areas in the magnetic recording medium, and
a second convexo-concave pattern corresponding to the data areas in the magnetic recording medium,
wherein a ratio L/S of a width “U” in a circumferential direction of a convex portion corresponding to a non-magnetic portion formed in the preamble area to a width “S” in a circumferential direction of a concave portion corresponding to a magnetic portion formed in the preamble area varies depending on a distance “R” from a center of the imprint mold structure to a center of a pattern unit composed of the convex portion and the concave portion in the first convexo-concave pattern.

2. The imprint mold structure according to claim 1, wherein the ratio L/S is within the range of from 0.33 to 0.83.

3. The imprint mold structure according to claim 1, wherein a ratio L/S of a width “L” in a radial direction of a convex portion corresponding to a non-magnetic portion formed in one of the data areas to a width “S” in a radial direction of a concave portion corresponding to a magnetic portion formed in the data area is kept constant.

4. A method for producing a magnetic recording medium, comprising:
using an imprint mold structure,
wherein the imprint mold structure is used for producing a magnetic recording medium having servo areas each of which has a preamble area where servo data for synchronization with a clock cycle is recorded, and data areas where user data is written, and the imprint mold structure comprises a first convexo-concave pattern corresponding to the servo areas in the magnetic recording medium and a second convexo-concave pattern corresponding to the data areas in the magnetic recording medium, and
wherein a ratio L/S of a width “L” in the circumferential direction of a convex portion corresponding to a non-magnetic portion formed in the preamble area to a width “S” in the circumferential direction of a concave portion corresponding to a magnetic portion formed in the preamble area varies depending on a distance “R” from a center of the imprint mold structure to a center of a pattern unit composed of the convex portion and the concave portion in the first convexo-concave pattern.

5. A magnetic recording medium, comprising:
servo areas each of which has a preamble area where servo data for synchronization with a clock cycle is recorded, and
data areas where user data is written,
wherein the magnetic recording medium is produced by a method for producing a magnetic recording medium which comprises using an imprint mold structure,
wherein the imprint mold structure comprises a first convexo-concave pattern corresponding to the servo areas in the magnetic recording medium and a second convexo-concave pattern corresponding to the data areas in the magnetic recording medium, and
wherein a ratio L/S of a width “L” in the circumferential direction of a convex portion corresponding to a non-magnetic portion formed in the preamble area to a width “S” in the circumferential direction of a concave portion corresponding to a magnetic portion formed in the preamble area varies depending on a distance “R” from a center of the imprint mold structure to a center of a pattern unit composed of the convex portion and the concave portion in the first convexo-concave pattern.
